(19) United States
(12) Patent Application Publication
(10) Pub. No.: US 2006/0124074 A1
(43) Pub. Date: Jun. 15, 2006

(54) Livestock flooring cover

(76) Inventors: Todd J. Koelker, Dyersville, IA (US); Kathy Koelker, Dyersville, IA (US)

Correspondence Address: ALLAN L HARMS, 2750 FIRST AVENUE NE, SUITE 420, CEDAR RAPIDS, IA, 52402, US

(21) Appl. No.: 11/301,929

(22) Filed: Dec. 13, 2005

Related U.S. Application Data
(60) Provisional application No. 60/635,465, filed on Dec. 13, 2004.
(60) Provisional application No. 60/647,349, filed on Jan. 26, 2005.

(51) Int. Cl. A01K 1/015; A01K 1/01

(52) U.S. Cl. 119/526; 119/529

(57) ABSTRACT

A slat cover for livestock flooring, particularly hog flooring, includes a base to overlie an individual slat of a floor of parallel individual slats, or a slat of a gang slat panel. Legs are joined to the base at the opposing sides of the base and terminate in an outwardly flared free edge. The legs are receivable in slots between individual slats or slots provided in a gang slat panel, the legs conforming to the corners of the slat and gripping the upper part of the opposing sidewalls of the slat. Traction bars or knobs or elastomeric strips are fixed to the upper surface of the base. A combination slat and alternate slat cover is also disclosed, the slat including a leg engaging region on each of its sidewalls. The alternate slat cover has a base with opposing downwardly extending legs which are integrally formed at a perpendicular to the base. Each leg includes a ridge to be received in a corresponding groove on the leg engaging region of the sidewall.

### CROSS-REFERENCE TO RELATED APPLICATIONS

This application claims priority from copending provisional patent application entitled “Livestock Flooring Cover”, Ser. No. 60/635,465 filed Dec. 13, 2004. This disclosure also incorporates the contents of copending provisional patent application entitled “Livestock Flooring Cover’, Ser. No. 60/647,349 filed Jan. 26, 2005. The disclosure of provisional patent application Ser. Nos. 60/635,465 and 60/647,349 are hereby incorporated in their entirety.

### FIELD OF INVENTION

This invention pertains to coverings for flooring in livestock raising facilities, and particularly to coverings for slotted floors for hogs.

### BACKGROUND

Present swine raising provides for the indoor housing of the animals from birth to market weight. In addition, slotted flooring may also be used in facilities to house gestating sows, as well as for facilities for beef and dairy cattle. The usual hog raising building is built over a manure collection pit and includes a slotted floor so that excrement from the animals will drop into the pit. Typically the floor is constructed of preformed concrete panels known as gang slats which are supported over the manure collection pit and include narrow slots through the panels. Livestock flooring may alternatively consist of individual beams (slats) separated by small gaps. Because of the width of slots within panels or between individual slats, especially if the flooring adjacent the slots becomes chipped or broken off, the hooves of young hogs may become caught in the slots, resulting in injury and probable destruction of the animal.

As flooring is occupied, wear results to it, especially around feeding areas. In addition, damage can occur leaving rough edges at the margins of the slots and enlargements in slot areas where slat material is broken next to a slot.

It is accepted knowledge that young pigs experience better health and growth when they are allowed to rest on plastic material rather than on concrete. Therefore efforts have been made to provide plastic flooring for hogs which have included gang slat panels constructed of rigid plastic to substitute for sections of concrete slat flooring, or plastic and rubber mats to overlie segments of concrete slat flooring in high use ares such as near feeders. In addition, floor structures manufactured of plastic have been developed to replace or to provide an overlying superstructure above an existing building floor.

Plastic slat panels are difficult to install when massive concrete slat panels must be removed to allow placement of plastic floor panels. Overlying floor mats may be anchored to the underlying concrete slats in order to prevent bunching or rollover due to movement and inquisitive activity of the pigs for pigs over about twenty-five pounds in weight. Installation of replacement floors made of rigid plastic is quite expensive. Placement and removal of non-anchored overlying mats is an inconvenience.

Because many existing hog confinement building floors are made of concrete slats, a need exists for a device which can simply but securely modify provide plastic slat flooring for hogs without having to remove slat panels or to anchor mats upon them or to build paneled superstructure floors over the existing concrete slat floors.

### SUMMARY OF THE INVENTION

The present invention pertains to flooring for use in hog raising buildings and particularly to modification of concrete slat flooring to add plastic covering to the top surface of such slat floors. Further, the invention provides apparatus which can be used to overlie a damaged or worn slat such as one with chips missing at the margins resulting in large gaps between slats. The invention also provides a cover for floor slats in high usage areas such as near feeders.

Generally, an overlying cap of formed plastic material may be snapped onto individual slats of a flooring panel which includes elongate slots. The invention includes a base area to overlie the top horizontal face of a slat. The base area is integral with depending legs which frictionally engage the tapered vertical surfaces of the slats, with the free edges of the legs provided with a slightly out turned flange to facilitate attaching the cap onto the slat. The legs narrow the gaps between slats but do not prevent passage of fecal material and urine from the top surface of the base through to the underlying collection pit. Spaced apart traction bars or strips may be formed on the top surface of the base so that footing of the pigs is enhanced without causing leg abrasions or other injury to the animals and while not interfering with cleaning of the cap. Elastomeric strips may be adhered to the top surface or integrated with the top surface when a cushioned top surface is desired.

Accordingly it is an object of the invention to provide an inexpensive repair for worn concrete slats, as well as to provide a wear reduction cover for high traffic areas of the hog floor near feeders. Further it is an object to provide easily installed plastic covers for concrete floor slats to provide a warmer environment for young hogs. Ultimately it is an object of the invention to provide for a healthier environment for young hogs resulting in improved weight gain and health of the swine.

These and other objects will become obvious from examination of the detailed description of the invention which follows.

### DESCRIPTION OF THE DRAWING FIGURES

FIG. 1 is a perspective of a section of livestock flooring with units of the invention covering parts thereof.

FIG. 2 is a perspective of a section of livestock flooring with a feeder at an end thereof and with units of the invention covering floor slats adjacent the feeder.

FIG. 3 is an enlarged perspective of a flooring slat with the first preferred embodiment of the invention mounted thereon.

FIG. 4 is an enlarged cross section of the first preferred embodiment of the invention.

FIG. 5 is a perspective, partly in section, of a gang slat panel with a unit of a second preferred embodiment of the invention mounted on one of the slats.

FIG. 6 is an enlarged cross section of a flooring slat adapted to receive the second preferred embodiment of the invention.

FIG. 7 is an enlarged cross section of a first alternative embodiment of the invention.

FIG. 8 is a perspective of a segment of a gang slat panel showing a modified unit of the invention mounted thereon bridging an unslotted region of the panel.

FIG. 9 is an enlarged perspective, in section, of a second alternative embodiment of the invention.

FIG. 10 is an enlarged perspective, in section, of a third alternative embodiment of the invention.

### DESCRIPTION OF THE INVENTION

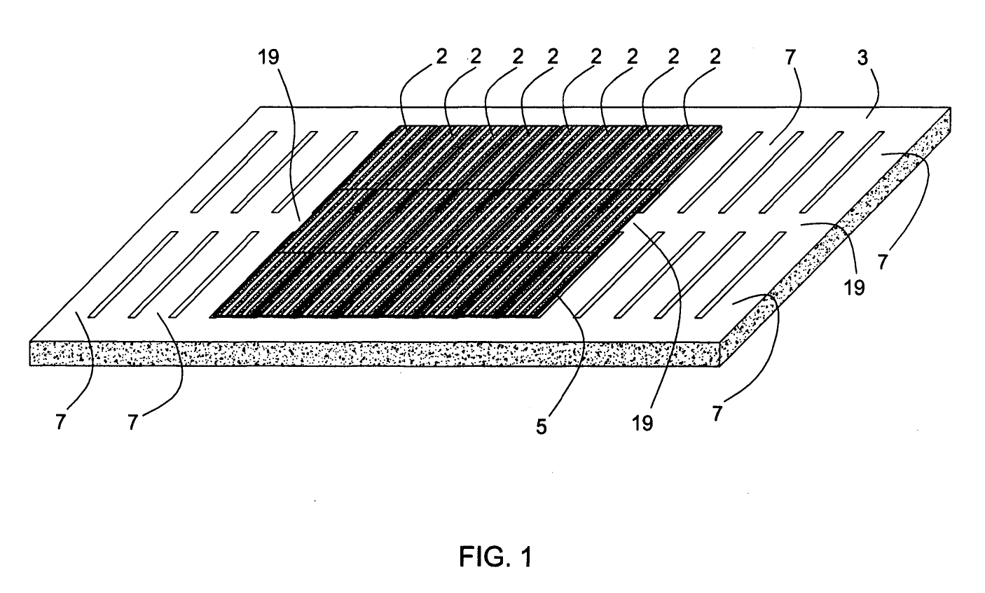

Referring to the drawings and specifically to FIG. 1, units of the first preferred embodiment of invention flooring cover 2 are shown installed on a section of livestock floor 3. Floor 3 is typically constructed of gang slat panels of preformed concrete and includes multiple parallel drainage slots 5 therethrough which define the flooring 3 into slats 7. Each unit of flooring cover 2 overlies a slat 7 and in the illustration of FIG. 1, uncovered slats 7 separate units of flooring cover 2. In the application illustrated in FIG. 1, a section of the livestock flooring 3 is provided with flooring covers 2 to provide a rest area on which animals, e.g. hogs, may lie. Flooring cover 2 is constructed of a rigid polymer to provide thermal insulation atop the concrete slat 7.

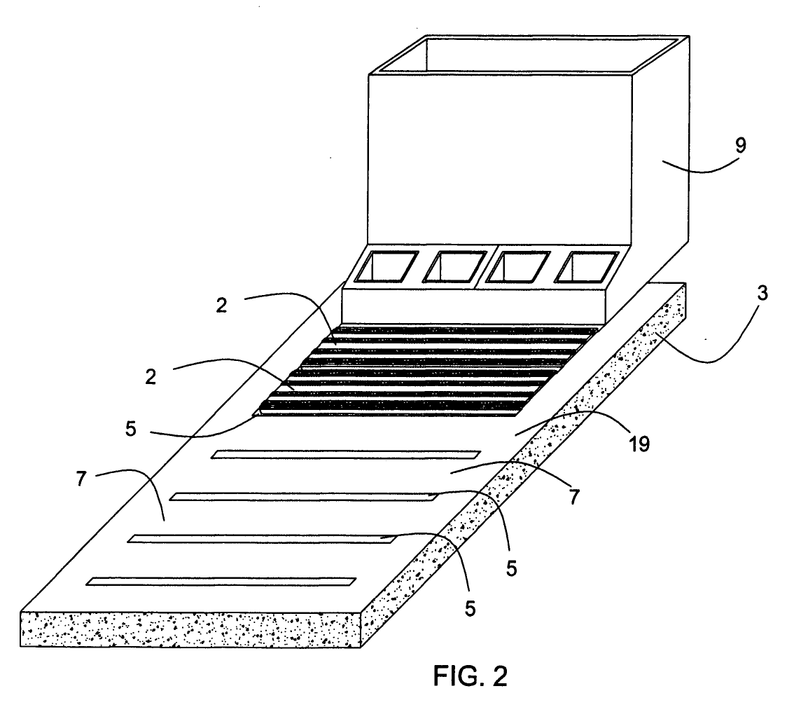

FIG. 2 illustrates an application for flooring cover 2 on a segment of floor 3 adjacent a feeding station 9 for hogs. Flooring covers 2 provide a replaceable wear absorbing area in the high traffic area used heavily by the hogs. In this application, flooring covers 2 are installed side by side on adjoining slats 7 of floor 3 and overlie a portion of the top surface 19 thereof.

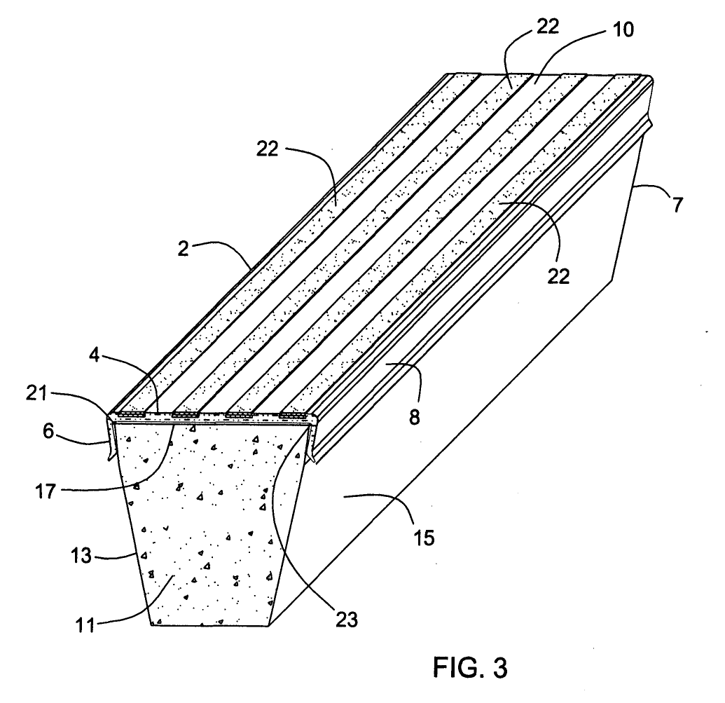

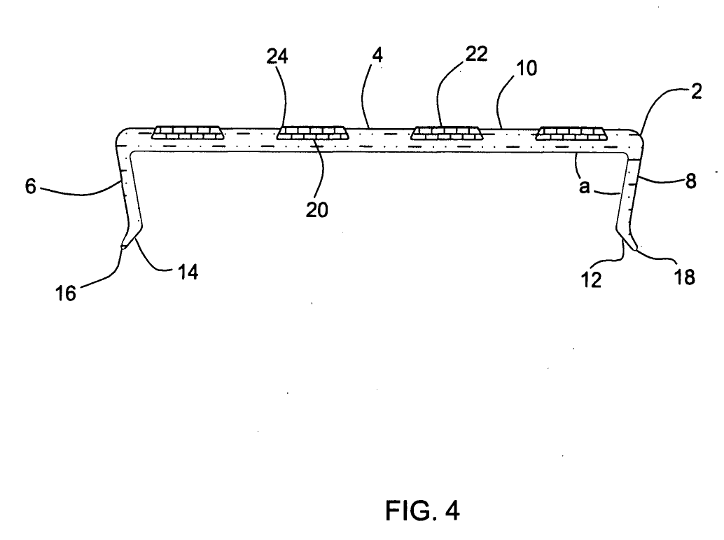

Referring now to FIGS. 3 and 4, detail of the first preferred embodiment flooring cover 2 may be visualized. In FIG. 3, a unit of flooring cover 2 is shown in place on a slat 7. Slat 7 may be a discrete beam or slat 7 may be a part of a gang slat panel supported over a collection pit. Slat 7 comprises an elongate body 11 with opposing sidewalls 13, 15 which slope convergingly from top to bottom. Flooring cover 2 comprises a base 4 which is sized to overlie the horizontal top surface 17 of slat 7. Base 4 comprises integral legs 6, 8 depending from base 4 at opposing sides thereof. Each of legs 6, 8 depends from base 4 at an acute angle a of about eighty-two degrees, such that legs 6, 8 will functionally grip sidewalls 13, 15 of slat body 11 respectively. The angular relationship between legs 6, 8 and base 4 replicates the angular relationship of each sidewall 13, 15 to top surface 17 of slat 7.

Legs 6, 8 and base 4 are integrally formed of substantially rigid or semirigid insulating material, preferably polymeric material and more preferably polypropylene or polyvinyl chloride. Legs 6, 8 are approximately ¼ inch in thickness; hence adjoining flooring covers 2 will not touch and a gap for passage of wastes will remain between adjacent floor covers 2.

Each of legs 6, 8 is provided with outwardly extending integral flanges 12, 14 at the free edges 16, 18 thereof respectively. Flanges 12, 14 are provided to facilitate installation of flooring covers 2 on slats 7 such that bearing of flanges 12, 14 upon the opposing upper corners 21, 23 of slat body 11 will cause legs 6, 8 to diverge as they pass comers 21, 23 and then legs 6, 8 will snap over comers 21, 23 and positively grip the upper parts of sidewalls 13, 15.

Top surface 10 of base 4 is provided with elongate indentations 20 into which elastomeric strips 22 are retained by adhesion or mechanical means. In the first preferred embodiment of flooring cover 2 seen in FIG. 4, elastomeric strips 22 are dovetailed into indentations 20 which have narrowed open tops 24. Elastomeric strips 22 may extend a very small distance above the top surface 10 of base 4, preferably less than 1/16 of an inch and more preferably about 1/48 inch. Strips 22 provide traction for the livestock walking on flooring covers 2. Each strip 22 may extend the full length of the flooring cover 2.

Referring again to FIG. 1 as well as to FIGS. 3 and 4, it may be understood that segments of legs 6, 8 may be removed at the interslot regions 19 of floor 3 such that flooring cover 2 may bridge interslot regions 19 while the remaining segments of legs 6, 8 will seat within slots 5. Because slots 5 are conventionally about an inch in width, installation of flooring covers 2 on adjacent slats 7 will narrow the gaps between adjacent flooring covers 2 to about ½ inch.

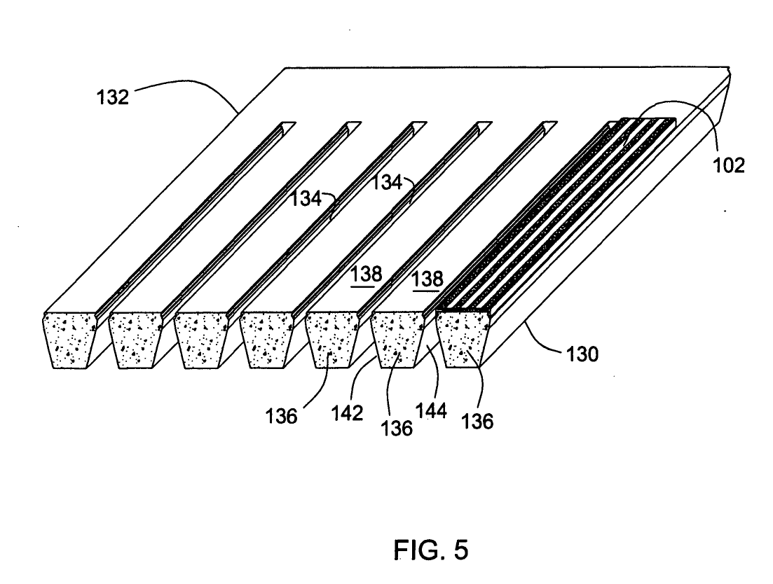

Referring now to FIG. 5, a new combination gang slat 130 and slat cover 102 is disclosed. Gang slat 130 comprises a preformed concrete panel 132 with multiple spaced apart parallel drainage slots 134 through which animal feces and urine may drain. Slots 134 are about two inches in width. The drainage slots 134 divide panel 132 into multiple elongate slats 136 with each slat 136 having a horizontal top face 138 and opposing upright sidewalls 116, 118. For ease of illustration in FIG. 5, flooring covers 102 have been omitted from all but the right-most slat 136 of gang slat 130.

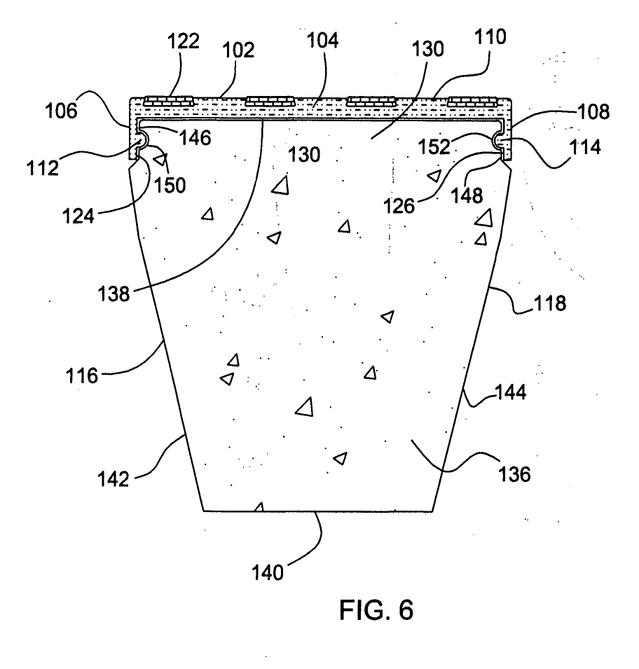

Referring additionally to FIG. 6, slat 136 is shown with second preferred embodiment slat cover 102 in place thereon. It may be seen that slat 136 is tapered from top to bottom such that the bottom 142 is narrower than top face 138 with generally upright sidewalls 116, 118 converging as they approach bottom 140. Each of sidewalls 116, 118, includes an upper region 146, 148 extending the length thereof, joined to and substantially perpendicular to top face 138. Upper regions 146, 148 are joined with lower regions 142, 144 of sidewalls 116, 118, the lower regions 142, 144 sloping convergingly inward as they approach bottom 140. Upper regions 146, 148 each comprise an elongate groove 150, 152 along the length thereof which serves as one element of a mating engagement pair.

Second preferred embodiment slat cover 102 includes a base 104 which includes downwardly extending legs 106, 108. Legs 106, 108 are semirigid and integrally formed with base 104 of polypropylene or polyvinyl chloride. Slat cover 102 may be formed as a unit by extrusion or preferably by injection molding. Each leg 106, 108 comprises an elongate longitudinal ridge 112, 114 along the inner face 124, 126 thereof. Ridges 112, 114 are received snugly into corresponding grooves 150, 152 of slat 136. Legs 106, 108 are integrally formed with base 104 and join base 104 at essentially a perpendicular.

The mating of ridges 112, 114 to grooves 150, 152 respectively provides a positive locking arrangement to secure cover 102 to slat 136.

Elastomeric inserts 122 are dovetailed into recesses 120 which extend substantially the full length of top surface 110 of slat cover 102. Inserts 122 are elongate strips of elastomeric material such as thermal plastic elastomer (TPE) which are slightly thicker than the depth of recesses 120 such that elastomeric inserts 122 protrude slightly above top surface 110 by about 1/48 inch.

Elastomeric strip inserts 122 may be replaced with an elastomeric layer secured to the entire top surface 110 of base 104, in an alternative embodiment.

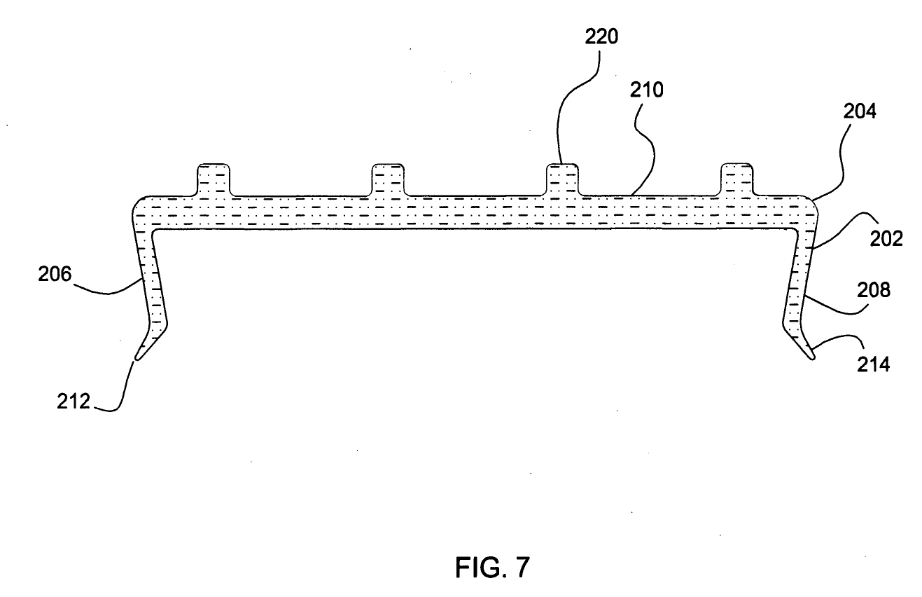

FIG. 7 discloses a first alternative embodiment of slat flooring cover 202. Slat flooring cover 202 comprises base 204 and integral legs 206, 208. Traction bars 220 are formed upon top surface 210 of base 204 and extend thereabove a small distance of approximately ¼ inch. Legs 206, 208 depend from base 204 at approximately seventy-five degrees to eighty-five degrees and preferably at about eighty-two degrees. Each leg 206, 208 includes an outwardly flared integral flange 212, 214. Slat flooring cover 202 may be used to snap fit onto an existing concrete slat and is sized to snugly overlie the slat.

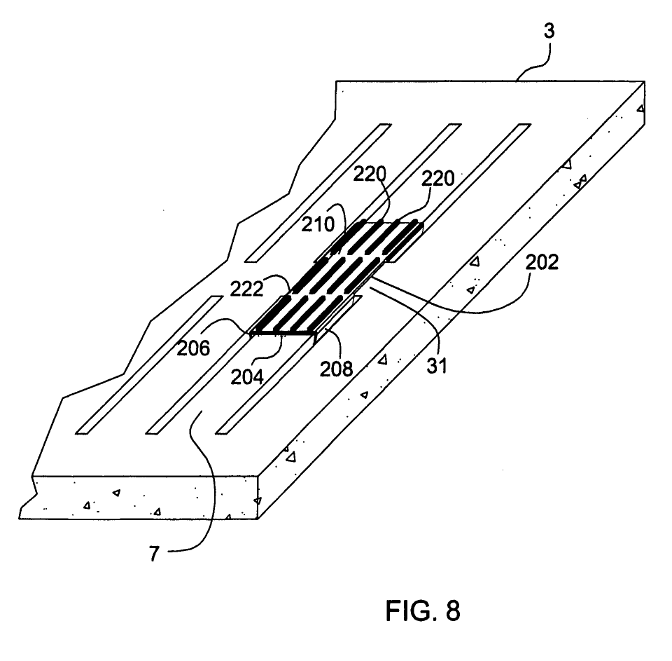

FIG. 8 reveals a segment of livestock floor 3 as in FIG. 1 comprising slats 7 separated by slots 5. Slats 7 are defined by slots 5 which do not extend the full dimension of floor 3 and are interrupted at bridge regions 31. Because there are no slots 5 in bridge regions 31 to receive legs 206, 208 of alternate embodiment flooring cover 202, segments of legs 206, 208 may be removed at their attachment to base 204 to permit flooring covers 202 to overlie bridge region 31.

Flooring cover 202 is provided with multiple integrally formed longitudinally spaced apart traction bars 220 protruding above top surface 210. Gaps 222 between the ends of traction bars 220 are formed to facilitate removal of debris such as mud and manure and to allow liquids to drain to the slots 5 between adjacent slats 7.

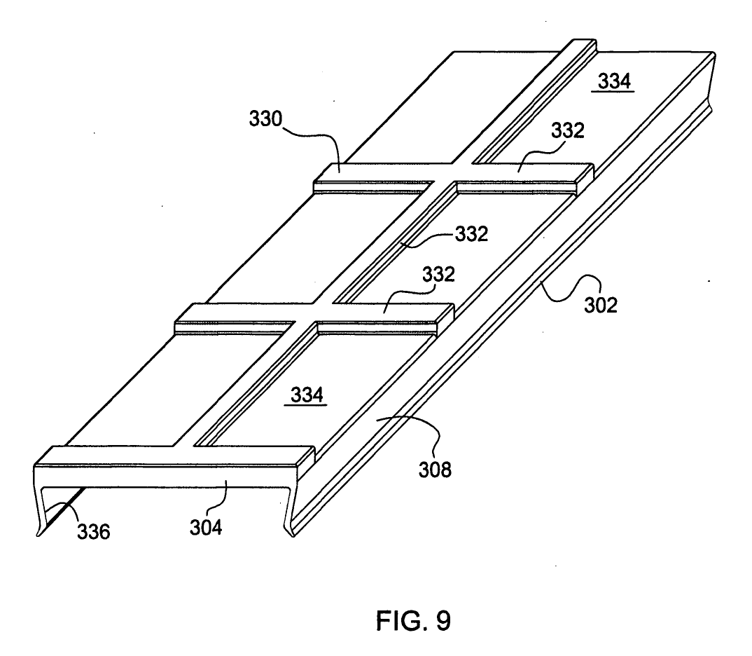

FIG. 9 discloses a segment of a third alternate embodiment slat cover 302 which comprises base 304 and legs 306, 308 at the opposing sides of base 304. Integrally formed with base 304 is a gridwork 330 of orthogonally joined raised bars 332 leaving recesses 334 therebetween. Recesses 334 may be sized to be about three inches by about two and a half inches, with bars 332 being about one-half inch in width and approximately ¼ inch in height.

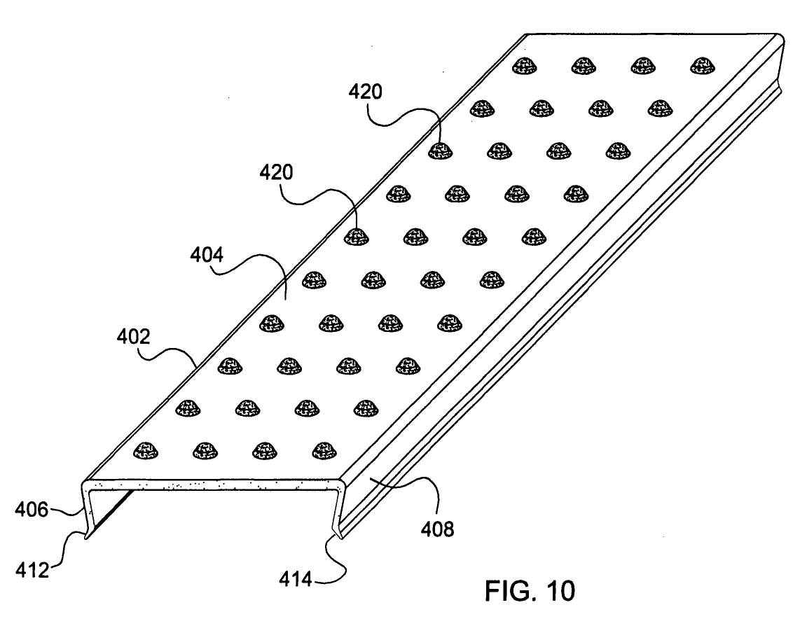

FIG. 10 discloses yet a fourth alternate embodiment flooring cover 402. Flooring cover 402 comprises a base 404 including integral depending legs 406, 408 with outward extending flanges 412, 414. A multiplicity of knobs 420 which are preferably domes but may be posts are integrally formed on and protruding from upper surface 410 of base 404 to provide a traction surface on upper surface 410. The legs 406 and 408 are arranged to grip the receding sidewall of a standard slat by being angled inwardly.

The advantages of providing any of the embodiments of flooring cover disclosed herein include providing a thermally insulated floor surface on which animals may lie or rest and to provide a repaired surface for a damaged slat floor. When a floor has suffered damage such as chips and breaks off the slat edges at the slots, the installation of a flooring cover will overlie the breakage and prevent an animal from stepping into an enlarged slot and having its hoof become caught. Use of the flooring cover of the present invention may also be used to retrofit a damaged or pocked floor by providing an improved surface or to provide a wear surface in heavy traffic areas.

Although the present invention has been described with reference to preferred embodiments, workers skilled in the art will recognize that changes may be made in form and detail without departing from the spirit and scope of the invention.

Having described the invention, I claim:

1. An insulative cover for livestock flooring having spaced apart generally parallel drainage slots therethrough, comprising
an elongate base overlying a segment of flooring between adjacent drainage slots thereof,
the base comprising opposing sides and legs depending from each of the sides,
each leg receivable within a drainage slot,
each leg retained to a sidewall of the flooring adjoining the drainage slot.

2. The cover of claim 1 wherein the base is thermally insulative.

3. The cover of claim 1 wherein the base and legs are integrally formed of semirigid polymeric material.

4. The cover of claim 3 wherein the base and legs are formed of polypropylene.

5. The cover of claim 1 wherein the base has a top surface with protrusions thereon.

6. The cover of claim 5 wherein the protrusions comprise spaced apart strips of elastomeric material.

7. The cover of claim 1 wherein
the base has a top surface with recesses therein,
elastomeric material retained in the recesses.

8. The cover of claim 7 wherein the elastomeric material extends above the top surface of the base.

9. The cover of claim 8 wherein the elastomeric material protrudes above the top surface less than 1/16 inch.

10. The cover of claim 7 wherein the recesses are spaced apart elongate recesses, the elastomeric material comprises elastomeric strips retained in the elongated recesses.

11. The cover of claim 3 wherein
each leg has a free end,
an outwardly directed flange on each free end.

12. A cover for a hog floor having parallel slats defined by spaced apart parallel drainage slots, the slats having a top face and opposing sidewalls, the opposing sidewalls sloping convergingly as said sidewalls extend below the top face, the invention comprising
an elongate polymeric base adapted to overlie the top face of one of the slats,
the base having opposing sides,
a leg depending from the base at each of the opposing sides,
each leg abutting a sidewall of the slat.

13. The cover of claim 12 wherein
the base and legs are integrally formed of semirigid polymeric material,
each leg having a free end,
an outwardly directed flange on each free end.

14. The cover of claim 12 wherein
an elastomeric layer fixed to a top surface of the base.

15. The cover of claim 13 wherein
the base having a top surface,
traction elements disposed on the top surface.

16. The cover of claim 14 wherein
the traction elements comprise a multiplicity of protruding bars.

17. The cover of claim 14 wherein
the traction elements comprise a plurality of upstanding elements.

18. The cover of claim 14 wherein
the traction elements comprise parallel strips of elastomeric material retained to the top surface of the base.

19. Livestock flooring comprising
a series of parallel spaced apart elongate slats defining drainage slots therebetween,
each slat having a top surface and an upper region and a lower region,
the upper region having opposing sidewalls depending from the top surface,
each sidewall of the upper region of each slat generally perpendicular to the top surface thereof,
a slat cover comprising a base adapted to overlie the top surface of the slat,
the base having opposing sides,
a downwardly depending leg member at each opposing side of the base,
each leg member having an inner face,
the inner face of each leg member abutting at least a portion of the sidewall of the upper region of the slat,
means to resist vertical sliding movement of the leg along the upper region.

20. The livestock flooring of claim 19 wherein
each sidewall of the upper region of each slat comprises a first engagement element thereon,
the inner face of each leg having a complementary engaging element thereon,
the complementary engaging element of each leg touchingly engageable with the first engagement element of the sidewall to which the inner face of the leg is abutted.

21. The livestock flooring of claim 20 wherein
the first engagement element is a longitudinal ridge or a longitudinal groove,
the complementary engaging element of each leg is a complementary longitudinal groove or longitudinal ridge matingly engageable with the first engagement element.
